(19) United States
(12) Patent Application Publication
(10) Pub. No.: US 2004/0013050 A1
(43) Pub. Date: Jan. 22, 2004

(54) Magneto-optical recording medium having two underlying layers having different characteristics and method of producing the same

(76) Inventor: Yukari Aoki, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/616,939

(22) Filed: Jul. 11, 2003

(30) Foreign Application Priority Data
Jul. 19, 2002 (JP) 211610/2002

(51) Int. Cl. G11B 11/00

(52) U.S. Cl. 369/13.47

(57) ABSTRACT

A magnetic layer having a third magnetic layer in which information is recorded and a first magnetic layer for regenerating information recorded in the third magnetic layer by displacing a magnetic domain wall is stacked on a substrate via first and second underlying layers to produce a magneto-optical recording medium. The second underlying layer adjacent to the first magnetic layer, and the first underlying layer is adjacent to the second underlying layer and on the side of the substrate. The first underlying layer and the second underlying layer have different densities.

### BACKGROUND OF THE INVENTION

1. Field of the Invention

The present invention relates to a magneto-optical recording medium in which information is recorded and regenerated by a laser beam using a magneto-optical effect of, for example, a magneto-optical disk.

2. Related Background Art

As information recording media capable of rewriting information, various kinds of magnetic recording media have become commercially practical. Particularly, a magneto-optical recording medium in which a magnetic domain is written in a magnetic thin film using thermal energy of a semiconductor laser to record information, and the recorded information is read out using a magneto-optical effect is looked upon with expectations as a large-capacity variable medium capable of high-density recording. In recent years, as dynamic picture images have been digitized, the need for enhancing the recording density of the magnetic recording medium to achieve a recording medium of larger capacity has been growing.

Generally, the linear recording density of an optical recording medium highly depends on the wavelength of a laser beam of a regeneration optical system and the numerical aperture NA of an objective lens. In other words, the beam waist diameter is determined only when the wavelength λ of the laser beam of the regeneration optical system and the numerical aperture NA of the objective lens are determined, and therefore the spatial frequency of a recording pit capable of signal regeneration is about 2NA/λ at the maximum. Thus, for achieving enhancement of density with a conventional optical disk, the wavelength λ of the laser beam of the regeneration optical system is reduced, or the numerical aperture NA of the objective lens should be increased. However, the reduction in wavelength λ of the laser beam is not easy because of problems associated with efficiency of a light-emitting device, heat generation and the like. In addition, if the numerical aperture NA of the objective lens is increased, a disadvantage arises that requirements for mechanical accuracy become stricter because the focus depth decreases and so on.

Thus, recently, various kinds of so called super-resolution techniques for modifying the configuration of a recording medium and the method for regeneration thereof to improve the recording density without changing the wavelength λ of the laser beam and the numerical aperture NA of the objective lens have been proposed.

For example, Japanese Patent Application Laid-Open No. 3-93058 discloses a signal regeneration method in which a signal is recorded in a record retaining layer of a multi-layered film comprising a regeneration layer and the record retaining layer magnetically bonded together, and directions in which the regeneration layer is magnetized are uniformalized, followed by applying a laser beam to heat the regeneration layer, and transferring the signal recorded in the record retaining layer to a heated area of the regeneration layer while reading the signal. According to the signal regeneration method, intersymbol interference during regeneration can be reduced, and the area heated by the regenerating laser beam to a transferring temperature to detect a signal can be limited to a smaller area with respect to the beam spot diameter of the laser beam, thus making it possible to regenerate a signal having a spatial frequency of 2NA/λ or greater.

However, the signal regeneration method described above has a disadvantage that since a signal detection area used effectively decreases with respect to the beam spot diameter of the regenerating laser beam, the amplitude of the regenerated signal is reduced, and therefore a sufficient regeneration output cannot be obtained. Thus, an effective signal detection area cannot be significantly reduced with respect to the beam spot diameter, and consequently significant enhancement of density cannot be achieved for the recording density determined by the diffraction limit of an optical system.

As one method for solving this problem, Japanese Patent Application Laid-Open No. 6-290496 discloses a regeneration method in which a magnetic domain wall existing on the boundary between recording marks (magnetic domains) is displaced toward the side of higher temperature according to a temperature gradient generated in a magneto-optical recording medium, thereby making it possible to regenerate a signal having a level of recording density exceeding the resolution of the optical system, without causing a reduction in amplitude of the regenerated signal.

The regeneration method will be described below.

FIG. 10 illustrates the magneto-optical recording medium disclosed in the application described above and its information regeneration principle, (a) of FIG. 10 is a sectional view schematically showing the configuration of the magneto-optical recording medium and the magnetized state of a portion exposed to a regenerating laser beam, (b) of FIG. 10 shows a temperature distribution generated in the magneto-optical recording medium during irradiation of the laser beam, and (c) of FIG. 10 shows a distribution of magnetic domain wall energy density σ of a magnetic domain wall displacement layer corresponding to the temperature distribution in (b) of FIG. 10.

As shown in (a) of FIG. 10, a magnetic layer 100 of this magneto-optical recording medium has a first magnetic layer 111 being the magnetic domain wall displacement layer, a second magnetic layer 112 being a switching layer and a third magnetic layer 113 being a recording layer stacked successively. Here, the first magnetic layer 111 is placed on the face exposed to a regenerating laser beam 120. The directions of arrows m₁ and m₂ in each of magnetic layers 111, 112 and 113 show the directions of atomic spins. A magnetic domain wall 116 is formed on the boundary between areas having the atomic spins of opposite directions. An arrow S shows a direction in which the magnetic domain wall is displaced.

The direction of an arrow r shows a direction in which a medium is shifted relative to a beam spot 120a, and the third magnetic layer 113 is shifted in the direction r, whereby the beam spot 120a is shifted along a recording track of the third magnetic layer 113. As shown in (b) of FIG. 10, an area exposed to this beam spot 120a has a temperature distribution such that the temperature starts to rise at a forward point of the beam spot 120a and reaches a peak at a position Xb in the direction along which the beam spot 120a is shifted. Here, the medium temperature reaches a temperature Ts near the Curie temperature of the second magnetic layer 112 at the position Xa.

As shown in (c) of FIG. 10, the distribution of magnetic domain wall energy density a in the first magnetic layer 111 generates such that the magnetic domain wall energy density σ decreases to a minimum at a point near the temperature peak behind the beam spot 120a, and increases on the forward side of the beam spot 120a. When the magnetic domain wall energy density σ has a gradient in the direction toward the position X in this way, a force F determined from the following equation (1) acts on the magnetic domain wall of each layer located at the position X.

F=∂σ/∂X (1)

This force F acts so that the magnetic domain wall 116 is displaced to the side of lower magnetic domain wall energy. Since the first magnetic layer 111 has a small magnetic domain coercive force and a high magnetic domain wall mobility, the magnetic domain wall 116 is easily displaced by this force F if the layer is a single layer. In an area located on the forward side of the beam spot 120a from the position Xa, however, the first magnetic layer 111 is exchange-coupled to the third magnetic layer 113 having a medium temperature lower than the temperature Ts and a large magnetic domain wall coercive force, and therefore the magnetic domain wall 116 is not displaced but fixed at a position corresponding to the position in the third magnetic layer 113 having a large coercive force.

In this magneto-optical recording medium, when the magneto-optical recording medium is shifted in the direction of arrow r, and the magnetic domain wall 116 of the first magnetic layer 111 is displaced to the position Xa, the medium temperature in the part of the magnetic domain wall 116 rises to the temperature Ts near the Curie temperature of the second magnetic layer 112, and exchange coupling of the first magnetic layer 111 and the third magnetic layer 113 is broken. As a result, the magnetic domain wall 116 of the first magnetic layer 111 is instantaneously displaced in the direction of arrow s shown by broken lines to a small area having a higher temperature and a lower magnetic domain wall energy density. When the magnetic domain wall 116 passes below the beam spot 120a, atomic spins of the first magnetic layer 111 are uniformalized in one direction in the range from the position Xa to the position Xb.

Each time the magnetic domain wall 116 formed by spaces between signals reaches the position Xa as the magneto-optical recording medium is shifted, the magnetic domain wall 116 in the first magnetic layer 111 is displaced instantaneously below the beam spot 120a, the recording magnetic domain extends over the range from position Xa to the position Xb, and atomic spins of the first magnetic layer 111 are uniformalized in one direction. As a result, the amplitude of the regenerated signal is always a constant and maximum amplitude irrespective of the space of the recorded magnetic domain wall (i.e. recording mark length), and thus problems of wave interference and the like caused by optical diffraction limits are fully eliminated.

In addition, it is proposed in Japanese Patent Application Laid-Open No. 11-191245, for example, that the magnetic domain wall is smoothly displaced by reducing the level of surface roughness of a substrate. This is because surface roughness of the substrate causes an impediment to the displacement (a magnetic domain wall coercive force on) when the magnetic domain wall is displaced.

However, in the magneto-optical recording medium in which information is regenerated utilizing the displacement of the magnetic domain wall, the magnetic domain wall coercive force of the magnetic domain wall displacement layer is reduced by reducing the level of surface roughness of the substrate, but it is extremely difficult to uniformalize the surface roughness of the substrate while the magnetic domain wall coercive force of the magnetic domain wall displacement layer acts uniformly over the entire recording and regenerating area. Unevenness of the magnetic domain wall coercive force resulting from unevenness of surface roughness of the substrate is a major factor of deterioration of regenerated signal characteristics.

If an adjustment is made from a stamper for eliminating this unevenness of surface roughness, there is a problem such that the production process of the magneto-optical recording medium is complicated and costs are increased because the surface roughness of the substrate depends on resist coating accuracy and the surface characteristics of matrix glass. In addition, if an injection-molded substrate is subjected to additional processing such as reverse sputtering processing, bake processing and UV ozone processing, there is also a problem such that the production process of the magneto-optical recording medium is complicated and costs are increased.

### SUMMARY OF THE INVENTION

The present invention provides a magneto-optical recording medium capable of improving regenerated signal characteristics with a simple configuration, and a method of producing a magneto-optical recording medium by which a magneto-optical recording medium having improved regenerated signal characteristics can be easily produced with simple production steps.

The magneto-optical recording medium of the present invention comprises:

a substrate;

at least first and second underlying layers provided on the substrate; and

a magnetic layer having at least a magnetic domain wall displacement layer in which a magnetic domain wall is displaced, a recording layer storing information, and a switching layer provided between the magnetic domain wall displacement layer and the recording layer, the switching layer having a temperature lower than that of the each magnetic layer,

wherein the second underlying layer is adjacent to the magnetic domain wall displacement layer, the first underlying layer is adjacent to the second underlying layer and on the side of the substrate, and the first underlying layer has a lower density than the second underlying layer.

In addition, a method of producing a magneto-optical recording medium according to the present invention comprises a film-forming step of forming the first underlying layer and the second underlying layer on the substrate by sputtering,

wherein in the film-forming step, the sputtering gas pressure during formation of the first underlying layer is higher than the sputtering gas pressure during formation of the second underlying layer.

In addition, another method of producing according to the present invention comprises a film-forming step of forming the first underlying layer and the second underlying layer on the substrate by sputtering,

wherein in the film-forming step, the distance between a target and the substrate during formation of the first underlying layer is larger than the distance between a target and the substrate during formation of the second underlying layer.

The present invention will be described in more detail in Embodiments described later.

### BRIEF DESCRIPTION OF THE DRAWINGS

FIG. 1 is a sectional view schematically showing a basic layer configuration of a magneto-optical recording medium of the first embodiment according to the present invention;

FIG. 2 is a schematic diagram showing one example of an optical system provided in a recording and regenerating apparatus for recording and regenerating a data signal for the magneto-optical recording medium of the first embodiment;

FIG. 3 shows the results of measuring the surface state of a second underlying layer in the first embodiment by using a scanning probe microscope, showing the three-dimensional image of surface state of a groove portion after the second underlying layer is formed;

FIG. 4 shows the results of measuring the surface state of a substrate in the first embodiment, showing the three-dimensional image of a surface shape of a groove portion being a recording and regenerating area;

FIG. 5 shows the results of measuring the surface state after a first underlying layer is formed on the substrate, showing the three-dimensional image of a groove portion after the first underlying layer is formed;

FIG. 6 is a sectional view schematically showing a basic layer configuration of the magneto-optical recording medium of Comparative Example 1;

FIG. 7 shows the results of measuring the surface state of the second underlying layer of Comparative Example 1;

FIG. 8 is a sectional view schematically showing a basic layer configuration of the magneto-optical recording medium of the second embodiment according to the present invention;

FIG. 9 is a sectional view schematically showing a basic layer configuration of the magneto-optical recording medium of Comparative Example 2; and

FIG. 10 illustrates the conventional magneto-optical recording medium and its information regeneration principle, in which (a) of FIG. 10 is a sectional view schematically showing a configuration of the magneto-optical recording medium and a magnetized state of an area exposed to a regenerating laser beam, (b) of FIG. 10 shows a temperature distribution formed in the magneto-optical recording medium during irradiation of the laser beam, and (c) of FIG. 10 shows a distribution of magnetic domain wall energy density σ of a magnetic domain wall displacement layer corresponding to the temperature distribution in (b) of FIG. 10.

### DETAILED DESCRIPTION OF THE PREFERRED EMBODIMENTS

As a result of continuously conducting vigorous studies, the inventor found that the surface of a normal injection-molded resin substrate (polycarbonate, etc.) has irregularities being equal to or larger than a recording mark length in scale and having an irregular cycle of (about 100 nm), and such irregularities cause unevenness of surface roughness of the substrate. The inventor has recognized that these irregularities can be flattened by an underlying layer provided between the substrate and a magnetic layer.

Specifically, the magneto-optical recording medium of the present invention is a magnetic domain wall displacement-type magneto-optical recording medium having a magnetic layer staked on a substrate via at least first and second underlying layers, the a magnetic layer having a recording layer in which information is recorded and a magnetic domain wall displacement layer for regenerating information recorded in the recording layer by displacing the magnetic domain wall, wherein the second underlying layer is adjacent to the magnetic domain wall displacement layer, and the first underlying layer is adjacent to the second underlying layer and on the side of the substrate. The first and second underlying layers have different densities.

The magneto-optical recording medium of the present invention having a configuration described above has at least two underlying layers provided between the substrate and the magnetic layer, in which the second underlying layer is provided on the side adjacent to the magnetic layer, and the first underlying layer having a relatively low density is provided on the side closer to the substrate, whereby irregularities on the surface of the substrate causing the unevenness of the displacement of the magnetic domain wall of the magnetic domain wall displacement layer are satisfactorily flattened by using the first underlying layer. That is, the surface roughness of the substrate before the magnetic layer is formed is uniformalized by the first underlying layer, thus making it possible to adjust the surface roughness of the substrate. Thus, according to the magneto-optical recording medium of the present invention, a magnetic domain wall coercive force acts uniformly in the entire recording and regenerating area, and therefore an excellent regenerated signal can be obtained.

Furthermore, underlying layers having different densities described above can be formed by adjusting the sputtering pressure and the distance between a target and the substrate during film formation.

(First Embodiment)

Embodiments of the present invention will now be described with reference to the drawings.

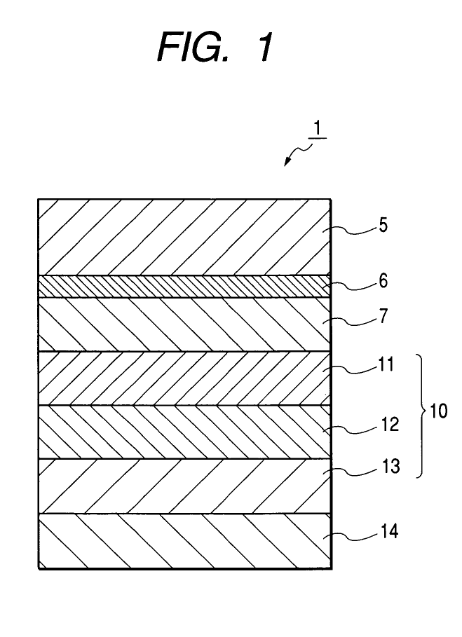

FIG. 1 is a sectional view schematically showing a basic layer configuration of a magneto-optical recording medium as the first embodiment of the present invention. As shown in FIG. 1, a magneto-optical recording medium 1 has a first underlying layer 6, a second underlying layer 7, a magnetic layer 10 and an overlying layer 14 stacked successively on a transparent substrate 5. In addition, the magnetic layer 10 has stacked thereon a first magnetic layer 11 being a magnetic domain wall displacement layer in which a magnetic domain wall is displaced, a third magnetic layer 13 being a recording layer for recording (storing) information, and a second magnetic layer 12 being a switching layer provided between the magnetic domain wall displacement layer and the recording layer and having a temperature lower than that of each of other magnetic layers, in the mentioned order from the side of the substrate 5. Furthermore, the first magnetic layer has a relatively small magnetic domain wall coercive force compared with the second magnetic layer and the third magnetic layer. Moreover, in addition to these layers, other auxiliary layers may be provided. The first magnetic layer 11, the second magnetic layer 12 and the third magnetic layer 13 are exchange-coupled at a temperature lower than the Currie temperature of the second magnetic layer 12.

For the substrate 5, for example, transparent polycarbonate, glass or the like is used. In this embodiment, a polycarbonate substrate having a track pitch of about 0.88 μm, a groove width of about 0.4 μm and a groove depth of about 60 nm is used.

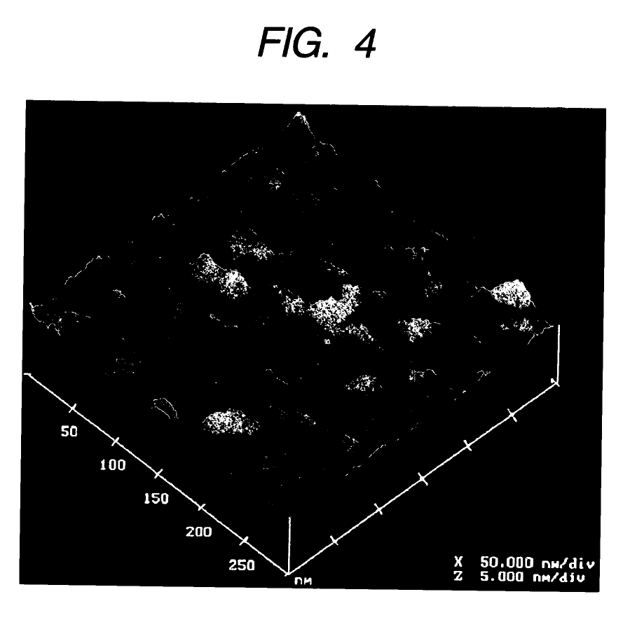

FIG. 4 shows the results of measuring the surface state of the substrate 5 for use in this embodiment by using a scanning probe microscope (Tapping Mode AFM manufactured by Digital Instrument Co., Ltd.), showing a three-dimensional image of a surface shape of a groove portion being a recording and regenerating area. As shown in FIG. 4, irregularities exist in a relatively large cycle of about 100 nm on the surface of the substrate 5.

For the first and second underlying layers 6 and 7, transparent dielectric materials such as Si₃N₄, AlN, SiO₂, SiO, ZnS and MgF₂ may be used. For the overlying layer 14 formed again as a protective layer, a similar dielectric material may be used. These layers can be formed by continuous sputtering using a magnetron sputtering apparatus, continuous vapor deposition or the like.

In this embodiment, SiN was deposited in the thickness of 5 nm as the first underlying layer 6 on the polycarbonate substrate 5 by a reactive sputtering process under a pressure of 0.6 Pa using a Si target while introducing Ar gas at 60 sccm and N₂ gas at 20 sccm.

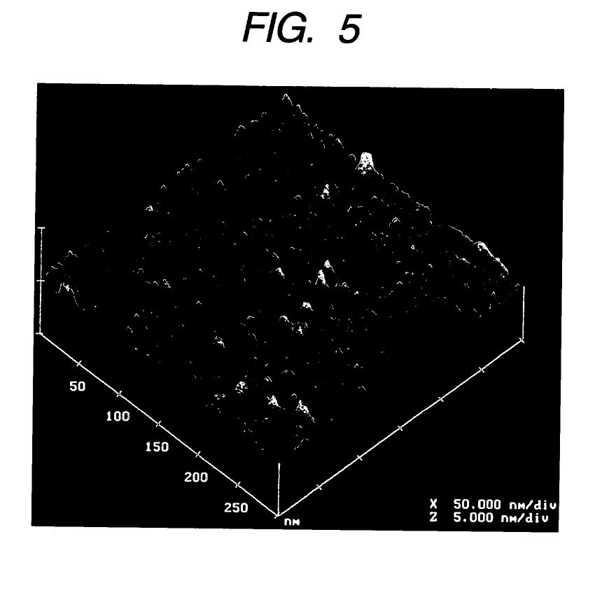

FIG. 5 shows the results of measuring the surface state by using the scanning probe microscope (Tapping Mode AFM manufactured by Digital Instrument Co., Ltd.) after the first underlying layer 6 is formed on the substrate 5, showing the three-dimensional image of surface state of a groove portion after the first underlying layer 6 is formed. As shown in FIG. 5, irregularities on the substrate 5 having a relatively large cycle of about 100 nm are flattened, and the height of irregularities is reduced. In this way, the first underlying layer 6 has an effect of flattening irregularities having a relatively larger cycle on the surface of the substrate 5.

After the first underlying layer 6 is formed, SiN is deposited in the thickness of 30 nm as the second underlying layer 7 by a reactive sputtering process under a pressure of 0.2 Pa while introducing Ar gas at 19 sccm and N₂ gas at 12.7 sccm. The second underlying layer 7 can be formed continuously after the first underlying layer 6 is formed under a sputtering gas pressure changed without interrupting transportation and breaking vacuum by changing the flow rates of gases after the first underlying layer 6 is formed. In this way, the second underlying layer 7 can be formed by changing only the atmosphere during film formation by sputtering using the same target, and therefore the production process is simplified.

Thus, according to the magneto-optical recording medium 1, the first underlying layer 6 having a density lower than that of the second underlying layer 7 is formed under a sputtering gas pressure higher than the sputtering gas pressure during formation of the second underlying layer 7.

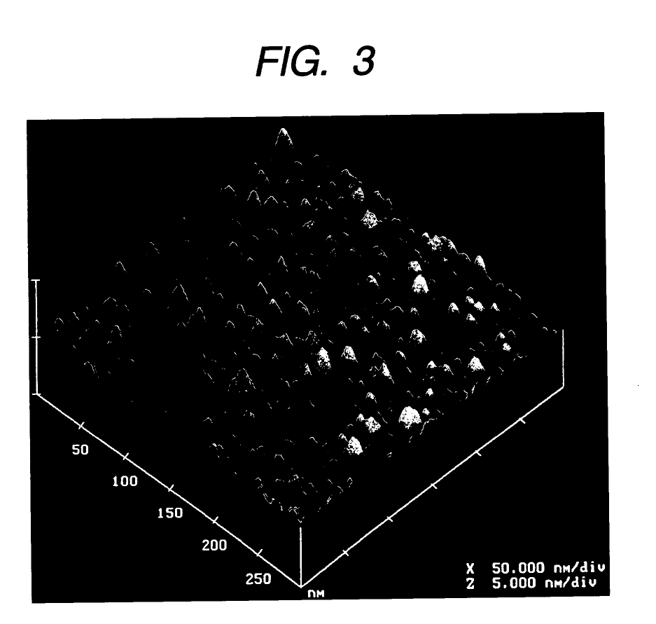

FIG. 3 shows the results of measuring the surface state of the second underlying layer 7 of this embodiment by using the scanning probe microscope (Tapping Mode AFM manufactured by Digital Instrument Co., Ltd.), showing the three-dimensional image of surface state of a groove portion after the second underlying layer 7 is formed. As shown in FIG. 3, by using the first underlying layer 6 having a relatively low density compared with the second underlying layer 7, very small irregularities on the substrate 5 having a cycle of about 20 nm can be uniformalized, and the magnetic domain wall coercive force uniformly acts, thus making it possible to obtain an excellent regenerated signal.

Furthermore, the first underlying layer 7 of this embodiment is formed in the thickness of 5 nm, but the thickness is set for the purpose of flattening irregularities on the substrate 5 having a relatively large cycle to uniformalize the surface roughness, and the thickness is not limited to 5 nm, and is preferably not smaller than the height of irregularities on the substrate 5. In addition, in this embodiment, 60 sccm of Ar gas and 20 sccm of N₂ gas are introduced to set the sputtering gas pressure at 0.6 Pa, but the sputtering gas pressure should not be limited thereto.

Moreover, in addition the two layers, i.e. first and second underlying layers 6 and 7, another underlying layer composed of a thin film may be formed between the first underlying layer 6 and the substrate 5 as necessary, or another film-forming step and the like may be added as long as the underlying layer 6 located closer to the substrate 5 than the second underlying layer 7 and having a relatively low density is provided. Moreover, the first underlying layer 6 may be formed with its density continuously changed.

Moreover, in addition to the configuration of the magneto-optical recording medium 1 of this embodiment, a metal layer made of, for example Al, AlTa, AlTi, AlCr, Cu or the like may further be deposited so that thermal characteristics can be adjusted. Moreover, a protective coating composed of a polymer resin may be added. In addition, substrates each having the respective layers formed thereon may be bonded together.

In addition, in the configuration of the magneto-optical recording medium 1 of this embodiment, it can be considered that the first, second and third magnetic layers 11, 12 and 13 are composed of various kinds of magnetic materials, and for example, they may be composed of rare earth element-iron group element amorphous alloys each constituted by 10 to 40 atomic % of one or more types of rare earth metal elements such as Pr, Nd, Sm, Gd, Tb, Dy and Ho and 90 to 60 atomic % of one or more types of iron group elements such as Fe, Co and Ni. In addition, for improving resistance to corrosion, a small amount of elements such as Cr, Mn, Cu, Ti, Al, Si, Pt and In may be added thereto.

In the case of the rare earth element-iron group element amorphous alloy, saturation magnetization can be controlled by the compositional ratio between the rare earth element and the iron group element. The Curie temperature can also be controlled by the compositional ratio, but for controlling the Curie temperature independently of saturation magnetization, a method in which a material with a part of Fe replaced by Co is used as the iron group element, and the replaced amount is controlled may be suitably used. Specifically, the Curie temperature is expected to rise by about 6° C. by replacing 1 atomic % of Fe with Co, and this relation can be used to adjust the amount of Co to be added so that a desired Curie temperature is obtained. In addition, the Curie temperature can be decreased by adding a very small amount of nonmagnetic element such as Cr or Ti. Moreover, the Curie temperature can also be controlled by using two or more types of rare earth elements to adjust the compositional ratio between the elements.

In addition to the materials described above, materials such as garnets, platinum group element-iron group element periodic-structured films and platinum group element-iron group element alloys can be used.

For the first magnetic layer 11, it is desirable that for example, a rare earth element-iron group element amorphous alloy having small perpendicular magnetic anisotropy such as GdCo, GdFeCo, GdFe or NdGdFeCo, or a material for bubble memory such as a garnet is used. For the third magnetic layer 13, materials having large perpendicular magnetic anisotropy so that the magnetized state can be retained with stability, for example, rare earth element-iron group element amorphous alloys such as TbFeCo, DyFeCo and TbDyFeCo, and platinum group element-iron group element periodic-structured films such as Pt/Co and Pd/Co are desirable.

In addition, at least the first magnetic layer 11 has exchange coupling broken between neighboring recording tracks in the in-plane direction. Consequently, the magnetic domain wall can be smoothly displaced along the recording track. This aspect can be achieved by subjecting magnetic layers between recording tracks to annealing processing by a high-power laser beam.

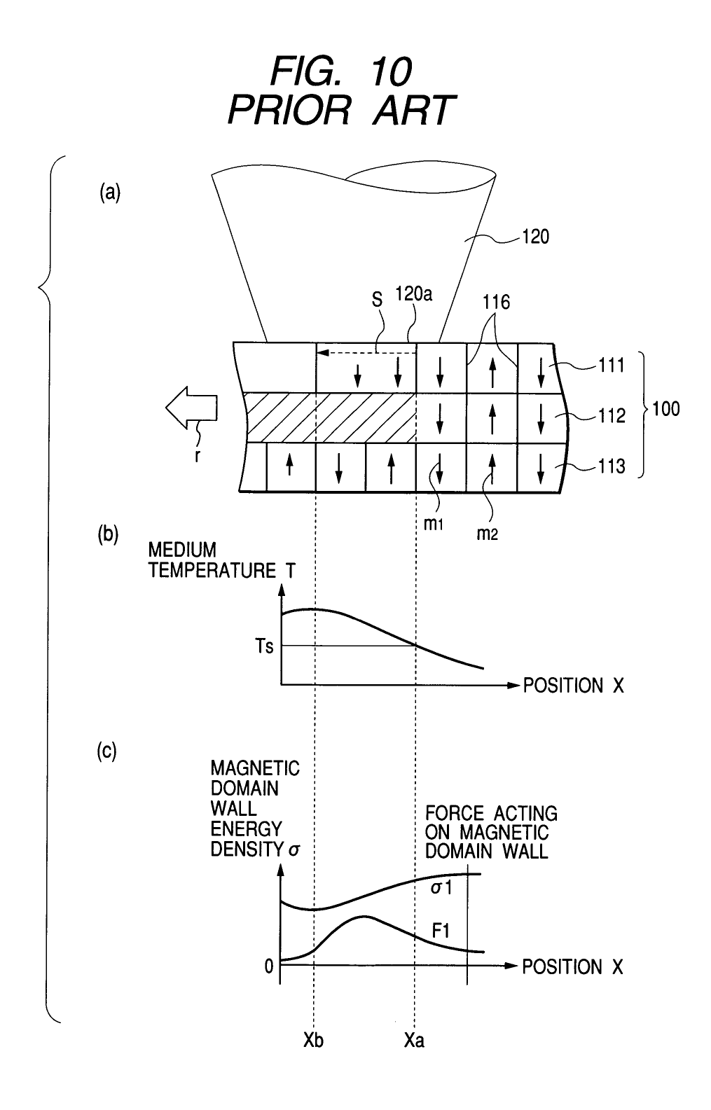

This operation of regenerating a data signal in the magneto-optical recording medium 1 of this embodiment is the same as that for the conventional magnetic domain wall displacement-type magneto-optical recording medium shown in FIG. 10. In addition, the recording of the data signal is carried out by moving the magneto-optical recording medium, and at the same time applying a laser beam 20 having a laser power, which rise the third magnetic layer 13 to the Curie temperature or more, along the recording track while modulating an external magnetic field according to a data signal to be recorded, or applying a magnetic field in a fixed direction while modulating the laser power according to the data signal to be recorded. In the latter case, by adjusting the intensity of the laser beam 20 so that only a predetermined area of a beam spot 20a is at a temperature near the Curie temperature of the third magnetic layer 13, a recording magnetic domain having a diameter equal to or smaller than the beam spot diameter can be formed, and as a result a signal can be recorded in a cycle equal to or less than the diffraction limit of the laser beam 20.

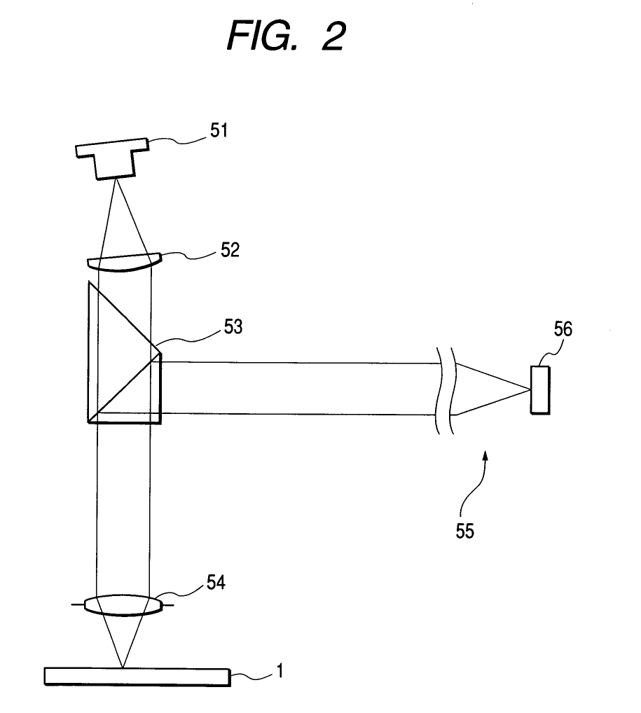

One example of an optical system provided in a recording and regenerating apparatus for recording and regenerating a data signal for the magneto-optical recording medium 1 of this embodiment is shown FIG. 2.

As shown in FIG. 2, the optical system comprises a laser beam source 51 emitting the laser beam 20, a collimator lens 52 converting into a collimated beam the laser beam 20 emitted from the laser beam source 51, a beam splitter 53 allowing the laser beam 20 from the laser beam source 51 to pass therethrough and reflecting back light from the magneto-optical recording medium 1, an objective lens 54 collecting the laser beam 20 passed through the beam splitter 53 to the magneto-optical recording medium 1, and a signal detecting system 55 having a detector 56 receiving back light reflected by the beam splitter 53, along the optical path. The laser beam source 51 is a recording and regenerating beam source, and the wavelength of the laser beam 20 is 680 nm. The beam splitter 53 has a correction portion correcting the laser beam 20.

In the recording and regenerating apparatus comprising the optical system having the configuration described above, by collecting the laser beam 20 with the wavelength of 680 nm emitted from the laser beam source 51, the recording and regenerating beam spot 20a is formed on a groove (or land) on the recording surface of the magneto-optical recording medium 1. The data signal is regenerated by moving the magneto-optical recording medium 1 at a linear speed of, for example, 2.7 m/sec while using the recording and regenerating beam spot 20a. Consequently, the magneto-optical recording medium 1 can be heated according to the temperature gradient shown in (b) of FIG. 10 during regeneration.

The first, second and third magnetic layers 11, 12 and 13 can be exchange-coupled to one another by forming the magnetic layers without breaking vacuum. Gd26.5Fe59.5Co12.2Cr1.8 was deposited in the thickness of 36 nm to form the first magnetic layer 11 as a magnetic domain wall displacement layer, a vertically magnetized film Tb25.54Fe74.56Cr1.9 of which the temperature Ts near the Curie temperature was about 150° C. as the lowest temperature compared to those of the other first and third magnetic layers 11 and 13 was deposited in the thickness of 10 nm to form the second magnetic layer 12 as a switching layer, and Tb25.52Fe45.07Co27.56Cr1.85 was deposited in the thickness of 60 nm to form the third magnetic layer 13 as a recording layer.

For the overlying layer 14, SiN was deposited in the thickness of 50 nm by the reactive sputtering process using a Si target while 19 sccm of Ar gas and 12.7 sccm of N₂ gas were introduced as in the case of the second underlying layer 7.

The regenerated signal was evaluated for the magneto-optical recording medium 1 having the configuration described above. The land portion was subjected to laser annealing processing, and evaluation of the signal was carried out in the groove portion. The recording of data signal was carried out by modulating an external magnetic field 300 (Oe: oersted [CGS electromagnetic unit system]) in 13.5 MHz while applying the laser beam 20 having a laser power of 3.5 mW, with the wavelength λ of the laser beam 20 of the recording optical system set at 680 nm, the numerical aperture NA of the objective lens 54 set at 0.55, and the linear velocity during recording set at 2.7 m/s. Data recorded in this way was regenerated using the laser beam 20 having a laser power of 2.2 mW. As a result, the magneto-optical recording medium 1 of this embodiment had a jitter value of 4.0 ns, and its regenerated signal characteristics were improved compared with a magneto-optical recording medium 61 having no first underlying layer shown in Comparative Example described later.

As described above, according to the magneto-optical recording medium 1, the first and second underlying layers 6 and 7 are formed between the substrate 5 and the magnetic layer 10, and the second underlying layer 7 is provided on the side adjacent to the magnetic layer 10, and the first underlying layer 6 having a relatively low density is provided on the side closer to the substrate 5, whereby irregularities on the surface of the substrate 5 causing unevenness of the displacement of the magnetic domain wall 16 of the first magnetic layer 11 are suitably flattened by the first underlying layer 16.

That is, the surface roughness of the substrate 5 is uniformalized by the first underlying layer 6, and thereafter the second underlying layer 7 is formed, thereby making it possible to adjust the surface roughness of the base before formation of the magnetic layer 10. Therefore, according to the magneto-optical recording medium 1, the magnetic domain wall coercive force acts uniformly over the entire recording and regenerating area, thus making it possible to obtain an excellent regenerated signal.

### COMPARATIVE EXAMPLE 1

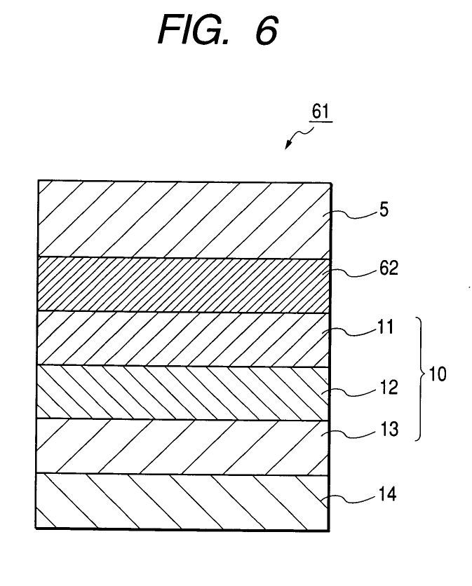

FIG. 6 is a sectional view schematically showing a basic layer configuration of a magneto-optical recording medium of Comparative Example 1. The magneto-optical recording medium of Comparative Example 1 has the same configuration as that of the magneto-optical recording medium 1 of the first embodiment except that the first underlying layer 1 is not formed, but only the second underlying layer is formed as an underlying layer. Furthermore, in the magneto-optical recording medium of Comparative Example 1, the same parts as those of the magneto-optical recording medium 1 described above are given the same symbols, and description thereof is omitted here.

As shown in FIG. 6, the magneto-optical recording medium 61 of Comparative Example 1 has an underlying layer 62 formed on a substrate 5. The underlying layer 62 provided in the magneto-optical recording medium 61 corresponds to the second underlying layer 7 provided in the magneto-optical recording medium 1.

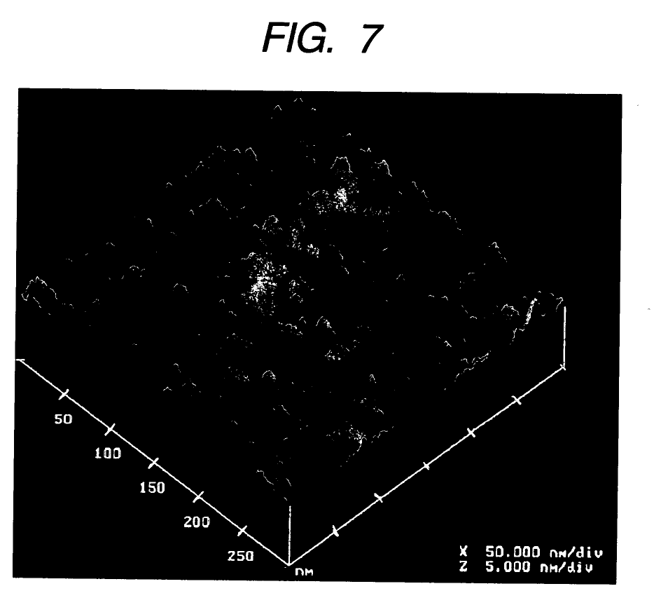

FIG. 7 shows the results of measuring the surface state of the underlying layer 62 of the magneto-optical recording medium 61 of Comparative Example 1 by using a scanning probe microscope (Tapping Mode AFM manufactured by Digital Instrument Co., Ltd.). FIG. 7 shows the three-dimensional image of a surface shape of the underlying layer 62 of a groove portion being a recording and regenerating area. As shown in FIG. 7, if the usual underlying layer 62 is directly formed on the surface of the substrate 5, irregularities having a relatively large cycle of about 100 nm remains on the surface of the substrate 5.

For the magneto-optical recording medium 61 of this Comparative Example 1, record and regeneration signal evaluations were made in the same manner as the magneto-optical recording medium 1 of the first embodiment described above. Here, the mark length for signal evaluation is 100 nm, and the cycle of irregularities on the surface of the underlying layer 62 of this Comparative Example 1 is approximately equal in scale to the mark length. As a result, the magneto-optical recording medium 61 of Comparative Example 1 had a jitter value of 4.6 ns, and its regenerated signal characteristics were inferior to those of the magneto-optical recording medium 1 of the first embodiment.

(Second Embodiment)

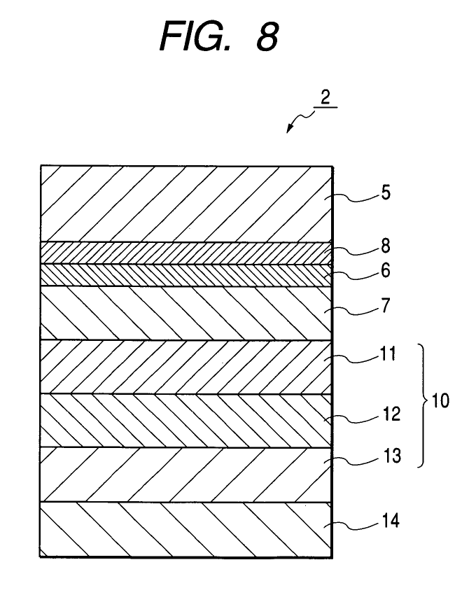

FIG. 8 is a sectional view schematically showing a basic layer configuration of a magneto-optical recording medium of the second embodiment of the present invention. The magneto-optical recording medium of the second embodiment has almost the same configuration as that of the magneto-optical recording medium 1 of the first embodiment except that a third underlying layer is further formed between the substrate and the first underlying layer. Furthermore, in the magneto-optical recording medium of the second embodiment, the same parts as those of the magneto-optical recording medium 1 described above are given the same symbols, and description thereof is omitted here.

As shown in FIG. 8, the magneto-optical recording medium 2 of the second embodiment has a third underlying layer 8 between the first underlying layer 6 and the substrate 5. For this magneto-optical recording medium 2, SiN was deposited in the thickness of 5 nm by a reactive sputtering process as the third underlying layer 8 under a pressure of 0.2 Pa using a Si target while introducing Ar gas at 19 sccm and N₂ gas at 12.7 sccm. Then, the flow rates of gases were changed and a first underlying layer 6 similar to that of the first embodiment was formed in the thickness of 5 nm on the third underlying layer 8, followed by depositing SiN in the thickness of 25 nm as a second underlying layer 7 under a pressure of 0.2 Pa while introducing Ar gas at 19 sccm and N₂ gas at 12.7 sccm.

The magneto-optical recording medium 2 of this embodiment has the same configuration as that of the magneto-optical recording medium 1 of the first embodiment except that the third underlying layer 8 is formed between the substrate 5 and the first underlying layer 6, and that the thickness of the second underlying layer 7 is 25 nm.

For the magneto-optical recording medium 2 of the second embodiment described above, record and regeneration signal evaluations were made in the same manner as the first embodiment. As a result, the magneto-optical recording medium 2 had a jitter value of 4.0 ns, and regenerated signal characteristics almost equal to those of the magneto-optical recording medium 1 of the first embodiment could be obtained.

### COMPARATIVE EXAMPLE 2

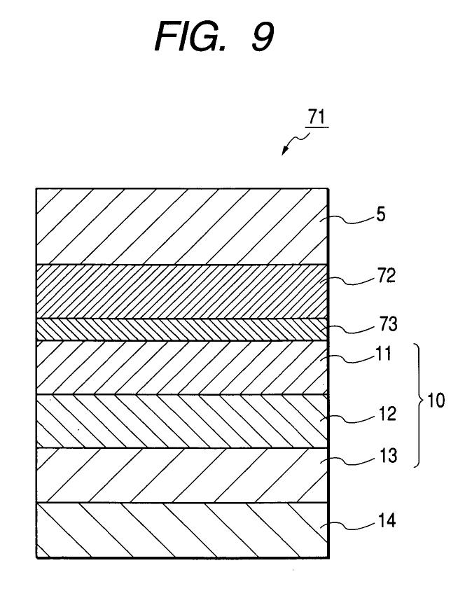

FIG. 9 is a sectional view schematically showing a basic layer configuration of a magneto-optical recording medium of Comparative Example 2 of the present invention. The magneto-optical recording medium of Comparative Example 2 has the same configuration as that of the magneto-optical recording medium 1 of the first embodiment except that the order in which the first underlying layer 6 and the second underlying layer 7 are formed on the substrate 5 in the above magneto-optical recording medium 1 is reversed. Furthermore, in the magneto-optical recording medium of Comparative Example 2, the same parts as those of the magneto-optical recording medium 1 described above are given the same symbols, and description thereof is omitted here.

As shown in FIG. 9, the magneto-optical recording medium 71 of Comparative Example 2 has a first underlying layer 72 and a second underlying layer 73 formed in this order on the substrate 5. The first underlying layer 72 provided in the magneto-optical recording medium 71 corresponds to the second underlying layer 7 of the magneto-optical recording medium 1, and the second underlying layer 73 provided in the magneto-optical recording medium 71 corresponds to the first underlying layer 6 of the magneto-optical recording medium 1.

SiN was deposited in the thickness of 30 nm as the first underlying layer 72 on the substrate 5 by a reactive sputtering process under a pressure of 0.2 Pa using a Si target while introducing Ar gas at 19 sccm and N₂ gas at 12.7 sccm, and subsequently SiN was deposited in the thickness of 5 nm as the second underlying layer 73 by the reactive sputtering process under a pressure of 0.6 Pa while introducing Ar gas at 60 sccm and of N₂ gas at 20 sccm.

For the magneto-optical recording medium 71 of Comparative Example 2 described above, record and regeneration signal evaluations were made in the same manner as the first embodiment described above. As a result, the magneto-optical recording medium 71 of Comparative Example 2 had a jitter value of 4.8 ns, and regenerated signal characteristics were poor compared with those of the magneto-optical recording medium 1 of the first embodiment.

(Third Embodiment)

The magneto-optical recording medium of the third embodiment has the same configuration as that of the magneto-optical recording medium 1 of the first embodiment except that the gas flow rate during formation of the first underlying layer is changed. SiN was deposited in the thickness of 5 nm as the first underlying layer by a reactive sputtering process under a pressure of 0.8 Pa while introducing Ar gas at 80 sccm and N₂ gas at 20 sccm.

For the magneto-optical recording medium of the third embodiment described above, record and regeneration signal evaluations were made in the same manner as the first embodiment. As a result, the magneto-optical recording medium of the third embodiment had a jitter value of 4.0 ns, and regenerated signal characteristics almost equal to those of the magneto-optical recording medium 1 of the first embodiment could be obtained.

(Fourth Embodiment)

The magneto-optical recording medium of the fourth embodiment has the same configuration as that of the magneto-optical recording medium 1 of the first embodiment except that the gas flow rate during formation of the first underlying layer is changed. SiN was deposited in the thickness of 5 nm as the first underlying layer by a reactive sputtering process under a pressure of 0.4 Pa while introducing Ar gas at 40 sccm and N₂ gas at 20 sccm.

For the magneto-optical recording medium of the fourth embodiment described above, record and regeneration signal evaluations were made in the same manner as the first embodiment. As a result, the magneto-optical recording medium of the fourth embodiment had a jitter value of 4.0 ns, and regenerated signal characteristics almost equal to those of the magneto-optical recording medium 1 of the first embodiment could be obtained.

(Fifth Embodiment)

The magneto-optical recording medium of the fifth embodiment has the same configuration as that of the magneto-optical recording medium 1 of the first embodiment except that the thickness of the first underlying layer is changed. SiN was deposited in the thickness of

10 nm as the first underlying layer by a reactive sputtering process under a pressure of 0.6 Pa while introducing Ar gas at 60 sccm and N₂ gas at 20 sccm.

For the magneto-optical recording medium of the fifth embodiment described above, record and regeneration signal evaluations were made in the same manner as the first embodiment. As a result, the magneto-optical recording medium of the fifth embodiment had a jitter value of 4.0 ns, and regenerated signal characteristics almost equal to those of the magneto-optical recording medium 1 of the first embodiment could be obtained.

(Sixth Embodiment)

The magneto-optical recording medium of the sixth embodiment has the same configuration as that of the magneto-optical recording medium 1 of the first embodiment except that the distance between the substrate 5 and the Si target is twice as large as that in the first embodiment, the flow rates of Ar gas and N₂ gas are changed to 19 sccm and 12.7 sccm, respectively, and the sputtering pressure is changed to 0.2 Pa when the first underlying layer is formed by the sputtering process. That is, in the film-forming step of this embodiment, the distance between the target and the substrate during formation of the first underlying layer is larger than the distance between the target and the substrate during formation of the second underlying layer.

For the magneto-optical recording medium of the sixth embodiment described above, record and regeneration signal evaluations were made in the same manner as the first embodiment. As a result, the magneto-optical recording medium of the sixth embodiment had a jitter value of 4.0 ns, and regenerated signal characteristics almost equal to those of the magneto-optical recording medium 1 of the first embodiment could be obtained.

What is claimed is:

1. A magneto-optical recording medium comprising:
a substrate;
at least first and second underlying layers provided on the substrate; and
a magnetic layer having at least a magnetic domain wall displacement layer in which a magnetic domain wall is displaced, a recording layer storing information, and a switching layer provided between said magnetic domain wall displacement layer and said recording layer, the switching layer having a temperature lower than that of the each magnetic layer,
wherein said second underlying layer is adjacent to said magnetic domain wall displacement layer, said first underlying layer is adjacent to said second underlying layer and on the side of said substrate, and said first underlying layer has a lower density than a density of said second underlying layer.

2. A method of producing a magneto-optical recording medium of claim 1, comprising a film-forming step of forming a first underlying layer and a second underlying layer on a substrate by sputtering,
wherein in said film-forming step, a sputtering gas pressure during formation of said first underlying layer is higher than a sputtering gas pressure during formation of said second underlying layer.

3. The method according to claim 2, wherein in said film-forming step, said second underlying layer is continuously formed on said first underlying layer by changing a gas flow rate after said first underlying layer is formed.

4. A method of producing the magneto-optical recording medium of claim 1, comprising a film-forming step of forming a first underlying layer and a second underlying layer on a substrate by sputtering,
wherein in said film-forming step, a distance between a target and said substrate during formation of said first underlying layer is larger than a distance between the target and said substrate during formation of said second underlying layer.
